(19) United States
(12) Patent Application Publication
(10) Pub. No.: US 2009/0222552 A1
(43) Pub. Date: Sep. 3, 2009

(54) HUMAN-COMPUTER PRODUCTIVITY MANAGEMENT SYSTEM AND METHOD

(76) Inventors: Mark Anthony Chroscielewski, Bellerose, NY (US); Alan Hedge, Ithaca, NY (US)

Correspondence Address: CLOCK TOWER LAW GROUP, 2 CLOCK TOWER PLACE, SUITE 255, MAYNARD, MA, 01754-2545, US

(21) Appl. No.: 12/040,854

(22) Filed: Feb. 29, 2008

(51) Int. Cl. G06F 15/16; G06F 17/30

(52) U.S. Cl. 709/224; 707/10; 707/E17.01

(57) ABSTRACT

The invention is a human-computer productivity management system with both processes and data systems designed to monitor the interactions between humans and computer systems, log the interactions, securely transmit the data to a centralized server, archive the data, process the data into highly efficient database, analyze the data to calculate productivity metrics, distill the data into key business intelligence reports and control the use of the computer systems.

### CROSS-REFERENCE TO RELATED APPLICATIONS

None.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2008 PRODYX Productivity Management Corp.

### BACKGROUND OF THE INVENTION

1. Field of the Invention

The invention relates to systems and methods for improving human work productivity in a computing environment.

2. Background

In the age of information, the productivity of an organization's workforce and the efficient utilization of its assets are critical factors for its overall success. Knowing what an organization's people do when they use computing devices can help to manage effectively an organization. When productivity is measured, productivity improves. Ironically, many organizations do little to measure the productivity of their employees. Measuring how much people work and how well they work is a key to improve efficiency of any organization.

At the start of the 20^{th} century, the growth in computer use marked a transition from an industrial economy to an information age. Yet, the concept of measuring and managing was largely overlooked. At the start of the 21^{st} century, employees were referred to as “information workers” and many argued that their productivity cannot be quantified because information work is mental work and not physical work. This argument overlooks several points. Knowledge workers are typically paid for their time rather than a specific output. The vast majority of work at a computer involves using either a keyboard, mouse, or speech recognition systems. Measuring and managing the amount of computer use and the accuracy of computer use would be extremely valuable to an organization.

3. Description of Prior Art

Key loggers have been around for many years as both commercial applications and as various virus and spyware implementations. There are many key loggers in the marketplace and they represent the earliest stages of rudimentary computer monitoring. Most key logging applications merely load keystroke sequences into a flat file and transmit the file to a monitoring application on another computer. The data file is typically filtered and/or sorted for the generation of reports. This approach, however, can make data analysis for more than a few computers tedious and hard to interpret. Most key logging applications are designed to generate alerts when user computer activity falls outside the boundaries of permitted uses.

In July of 2002, PC Magazine reviewed six activity monitoring tools for the Windows platform (www.pcmag.com/article2/0,2817,272723,00.asp). These applications extended the key logging tools to monitor application usage, web sites visited, online chat sessions, instant messaging conversations and email content. These applications are also capable of capturing screen images on either a periodic basis or in response to a specific, predetermined event trigger. Although these advances improved the monitoring functionality of the applications, all of the applications in the review failed to improve the effectiveness or quality of their reporting. The author summarized the review by saying “no product in the activity-monitoring space is ready for prime time.”

Of the six products tested, only two remain active in the 2008 market; SpectorSoft's Spector Pro (www.spectorsoft.com) and Spytech's SpyAgent (www.spytech-web.com/spyagent.shtml). Both are products that have been in the market for over 5 years. More recently, Awareness Techology's Sonar has entered the marketplace. Sonar is an advanced logging application with many new features. However, all of these applications are based on old logging and communication methodologies and focus primarily on limiting user access to desktop applications and internet sites (web, IM, chat, email, etc.).

None of these applications recognizes a need to archive massive amounts of data from large user populations on multiple computer platforms. All of theses applications operate on a predefined event trigger model that requires key words, files names and internet sites to be defined, in advance, to trigger filtered events and generate alerts. In other words, these applications focusing on policing computer users.

These applications are analogous to a stock market tickertape that streams raw data transactions to subscribers. The data stream can be filtered to identify key transactions or events and alert investors watching the market in real time, but the tickertape can not begin to match the power of market analysis tools designed to identify trends and derive key insights that help market professionals make sound investment decisions.

In like manner, none of these applications focus on analyzing logged data to derive quantitative measures of human-computer productivity (or leakage). These applications to not contemplate identifying changes in productivity over time, or quantifying a cost of productivity leakage to an organization.

There are also patent documents that relate to computer monitoring.

U.S. Pat. No. 5,675,510 issued to Coffey, et al., Oct. 7, 1997 and titled “Computer Use Meter and Analyzer” discloses an invention that measures and reports on applications used by a personal computer. Coffey is focused on capturing information about open windows and the URL addresses for world wide web pages visited by the user. Entries in the log are based on a predetermined set of operating system triggers and events. A system log is compressed, encrypted and transmitted to a central processing server on a periodic basis, once a month by default. Coffey is designed to discern computer usage habits and patterns and is primarily focused on generating marketing intelligence for computer hardware, software and communication companies. The benefit of Coffey is analogous to the television rating and viewer demographics that television advertisers rely on to build marketing and media plans.

U.S. Pat. No. 5,696,702 issued to Skinner, et al., Dec. 9, 1997 and titled “Time and Work Tracker” discloses an invention that monitors human-computer interactions and logs results to a file stored on the computer workstation. Skinner is specifically designed to track files and time used for specific projects and tasks and is focused on generating work activity records for telecommuters or consultants and independent contractors that must document work activity for client invoicing.

U.S. Pat. No. 6,397,256 issued to Chan, et al., May 28, 2002 and titled “Monitoring System for Computers and Internet Browsers” discloses an invention specifically designed to monitor internet usage. Chan includes an internet access unit (typically a personal computer), a transmission unit installed on the internet access unit that captures internet usage details and a remote monitoring unit that is coupled to the transmission unit, receives the data from the transmission unit, summarizes the data and displays it for viewing on the monitoring unit display. Chan is designed specifically to overcome the limitations of firewall and filtering technologies that had been previously used to control access to inappropriate and undesirable materials on the internet.

U.S. Pat. No. 6,446,119 issued to Olah, et al., Sep. 3, 2002 and titled “System and Method for Monitoring Computer Usage” discloses an invention, similar to that of Chan et al., that is designed to monitor internet access by children, students and workers. Unlike Chan's approach, however, Olah monitors internet usage by capturing screen images at predetermined intervals and forwarding those images to an operator that reviews the images and determines if the usage is appropriate for the specific situation.

None of the systems described above offer a comprehensive, integrated human-computer productivity management system. All focus on capturing data with little or no attention to deriving quantitative business intelligence that can be used to measure human-computer interactions and improve productivity. What is needed, therefore, is a comprehensive system to monitor human-computer interaction, measure workforce productivity and optimize the use of personal computers. What is further needed is such a system that protects the privacy of computer users, and can easily scale to meet the needs of large organizations.

### BRIEF SUMMARY OF THE INVENTION

The invention is a human-computer productivity management system with both processes and data systems designed to monitor the interactions between humans and computer systems, log the interactions, securely transmit the data to a centralized server, archive the data, process the data into highly efficient relational database, analyze the data to calculate productivity metrics, distill the data into key business intelligence reports and control the use of the computer systems. The invention includes processes and related data systems controlling the interactions between humans and computers.

The processes for monitoring, measuring and controlling the human-computer interaction includes several steps. A small piece of monitoring software is installed on personal computers or other computing devices. Interaction are logged, then compressed and encrypted. Data is transmitted to a centralized data management server for archiving, processing and analyzing the data. Reports are generated with actionable business intelligence. The invention can optionally be used to disable or control computing devices.

A client-server computing architecture is the basis for the data management system. A software client application monitors and logs human-computer interactions. The client application is also known as a “beacon.” Preferably, a SOAP-based communication client is used for compressing, encrypting and transmitting the interaction data to a centralized server. Data is stored using a relational and multidimensional database. A management application provides for analyzing and reporting results, and for controlling or disabling a computer.

These processes, the related data management systems and the resultant management reports give an organization the ability to monitor human-computer interactions, measure the effectiveness of its workforce, control the use of its computers, improve productivity, protect its intellectual property, guard trade secrets, and minimize the risks associated with the use of personal computers and global communication networks in the workplace.

In one embodiment, the invention is a computerized method for managing productivity in a human-computer environment. Human-computer interactions are monitored on a plurality of computing devices. Computing devices include any personal computer, workstation, laptop, PDA or other electronic device capable of running monitoring software. Human-computer interactions are logged. Logged data is encrypted, compressed, and transmitted to a data management server. The data is indexed and archived in a relational database. With archived data, the invention is capable of analyzing, calculating and displaying statistical information about the archived data. Archiving is a significant step forward. Prior key logging programs only store data for a week or month—especially since screen images are often captured which can easily create memory problems. The present invention does not store visual screen captures. The invention can also use a analytic or multidimensional database for overlaying and correlating external data sources with archived data. Archiving data results in the ability to display statistical data as a function of time. Preferably, displayed data relates to human productivity.

Human computer interactions can be monitored and logged without defining an event, keyword, or activity category to trigger logging. Preferably, keystroke logging is not sequenced. The invention keeps data on number of keystrokes for specific keys and for specific times, but without storing sequences. The invention also logs data without capturing screen images or using any kind of screen scraping. The invention logs title bars of windows, URLs, and applications accessed. Archived data can be compared with external sources of data such as org charts, job descriptions, geographic locations, office air temperature, carbon dioxide levels, lighting conditions, VOIP access, and so forth. Analyzing archived data enables operators to learn all about user effort, without having work product or content data.

The invention can identify computing devices that have ceased to transmit data to a data management server. Optionally, productivity measurements are automatically generated from the archived data. The invention can control or disable computing devices in response to user instructions.

Any number of productivity measurements can be selectively displayed. The invention can display measurement identifying user fatigue, or amount of paid internet advertising by advertisers. The invention can automatically categorize work and non-work user activities, and track productivity data by geographic location.

### FEATURES AND ADVANTAGES

There are several features and advantages of the present invention. A monitoring application runs on all major personal computer platforms, not just the Windows platform.

The invention supports for multiple distribution and installation methodologies. The invention is capable of logging all human-computer interactions, not just application layer activities including keyboard activity, mouse activity, computer applications, internet and web activity, electronic mail and other communication activities, file access and hardware level disk and I/O operations.

The invention protects the privacy and security of passwords, account numbers and other sensitive data. The invention does not require predetermined key words or definitions of interactions to be stored in event logs. The invention does not require additional hardware, software, capital investment or support from an organization's information technology department.

The invention can operate on an organization's internal network or as a standalone workstation (a mobile worker or remote telecommuter). The invention can stream data in real-time if an internet connection is available, or store data locally until a user reconnects to the internet. The invention compresses and encrypts interaction data before, during and after transmission to a central server. The invention automatically detects non-reporting computers.

The invention provides a highly scalable database platform to archive massive data streams from large user populations and allow retrospective analysis of data. The invention provides for real-time, ad-hoc data queries and analysis. The invention provides automatic generation of productivity, security and other quantitative measures of the human-computer interaction. The invention delivers real-time business intelligence on any computer, cellular phone, handheld PDA device or other web enabled device. Continuously archived data provides a rich analytical environment

The invention includes real-time capability to control, limit or disable computer usage. The invention automatically downloads program updates for the monitoring application or other computer software programs.

The invention enhances organizational productivity and efficiency such as optimizing application interface design, measuring user fatigue and quantifying the cost/benefit ratio for workforce training and facility redesign.

### BRIEF DESCRIPTION OF THE DRAWINGS

In the drawings, closely related figures and items have the same number but different alphabetic suffixes. Processes, states, statuses, and databases are named for their respective functions.

FIGS. 1A & 1B show a system diagram and flow chart showing the entire productivity management system process.

FIG. 2 shows a file format for a keyboard and mouse workstream log file.

FIG. 3 shows a file format for an application and window workstream log file.

FIG. 4 shows a file format for a disk activity workstream log file.

### DETAILED DESCRIPTION OF THE INVENTION, INCLUDING THE PREFERRED EMBODIMENT

The following detailed description of the invention references the accompanying drawings which form a part hereof, and in which are shown, by way of illustration, specific embodiments in which the invention may be practiced. Other embodiments may be used, and structural changes may be made without departing from the scope of the present invention.

Operation

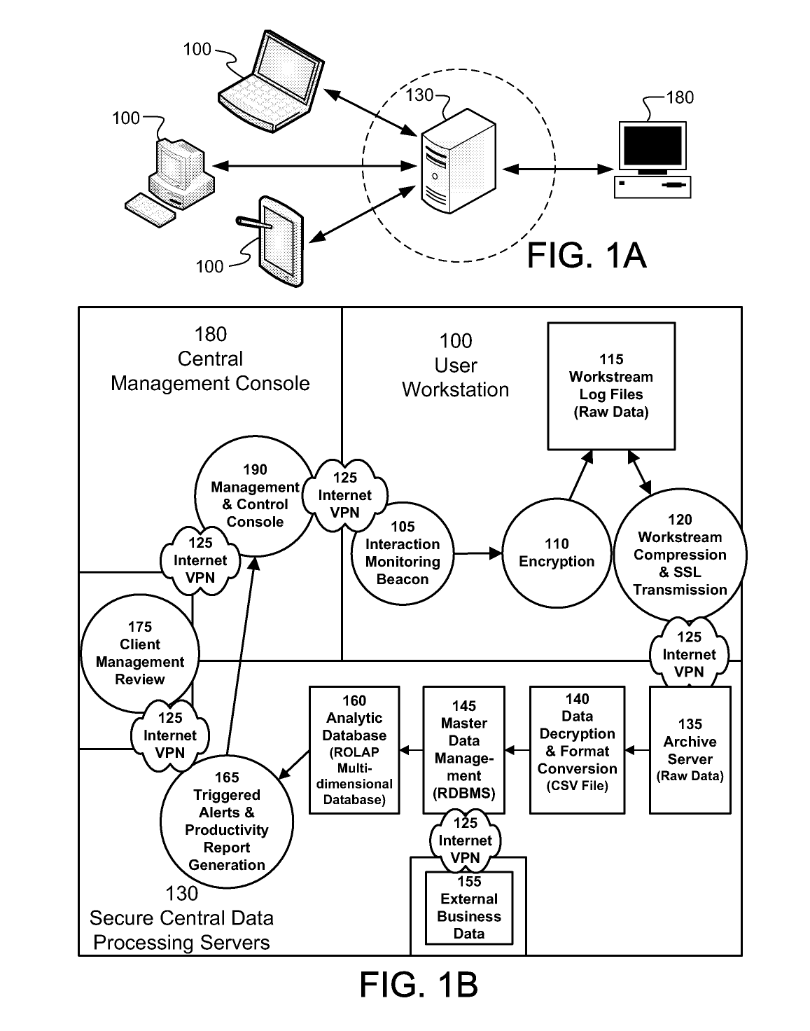

FIGS. 1A and 1B show detailed processes and data systems required for the invention.

User Workstation

Users workstations 100, central data processing server(s) 130, and central management console 180 are used in the preferred embodiment of the invention. Interaction monitoring beacon 105, that runs on the user workstations 100, is a software program that captures human-computer interactions. The interactions or workstream captured by the beacon 105 are encrypted (110) and stored in three workstream log files 115. Interactions are counted and accumulated.

Monitoring beacon 105 runs on at least the four major personal computer platforms (Microsoft Windows, Apple Macintosh, Linux and Unix). Interaction monitoring beacon 105 consists of a set of executable files and shared libraries that can be installed using any generally available method for each platform. Depending on the workstation platform, modifications of registry and profile files are required to start interaction monitoring beacon 105 whenever the computer is started or rebooted.

The preferred embodiment on the Microsoft Windows platform uses a standard Windows MSI Installer. Beacon installation can be configured to be silent (the end user is unaware of the installation of the software) if the organization does not want their users to be aware of the monitoring program.

In the preferred embodiment, the files are installed on Microsoft Windows computers as part of a standard network login script. An alternative embodiment useful for computers not connected to local area networks or shared file servers uses a JAVA application which, after installation, presents a workstation user with a questionnaire but loads interaction monitoring beacon files in the background. As with standard installation, JAVA installation can be configured to run silently.

In the preferred embodiment, log files are stored in a directory on the workstation hard disk drive, are hidden from the user, and the user is prevented from removing the program from either their hard disk drive or the system registry. All of these parameters can be configured for each installation depending on instructions of an organization administrator.

Human-computer interactions are intercepted by interaction monitoring beacon 105 using standard hooks that are part of the Windows API. On Microsoft Windows computers, these hooks are used to intercept all keyboard activity, mouse movements, change of focus, window, application, web, file system, input/output and other events.

On Linux and Unix computers, hooks in the Xwindows API are used to intercept all interaction events except for file movements. In the preferred embodiment, a proprietary “interposer” library is installed to intercept file system calls. The Apple Macintosh computer can run Xwindows in which case the hooks in the Xwindows API can be used to intercept interaction events. If an Apple Macintosh computer is not running Xwindows, then hooks in the native Macintosh windows API (Carbon) are used. In most installations, both methods are employed since users can run both Xwindows and native Macintosh applications simultaneously. Applescript is used to capture windows titles.

Human-computer interactions captured by monitoring beacon 105 are stored as workstreams in workstream log files 115 after encryption (110). Workstreams represent a range of human-computer interactions including, but not limited to, keyboard workstreams, mouse workstreams, application & window workstreams, web and communication workstreams, file access and input/output workstreams and hardware identification workstreams (user ID, MAC address, IP address).

Interaction workstreams captured by monitoring beacon 105 are encrypted (110) and stored in three log files 115. The preferred embodiment uses a 128 bit variable key for encryption but other methods are usable.

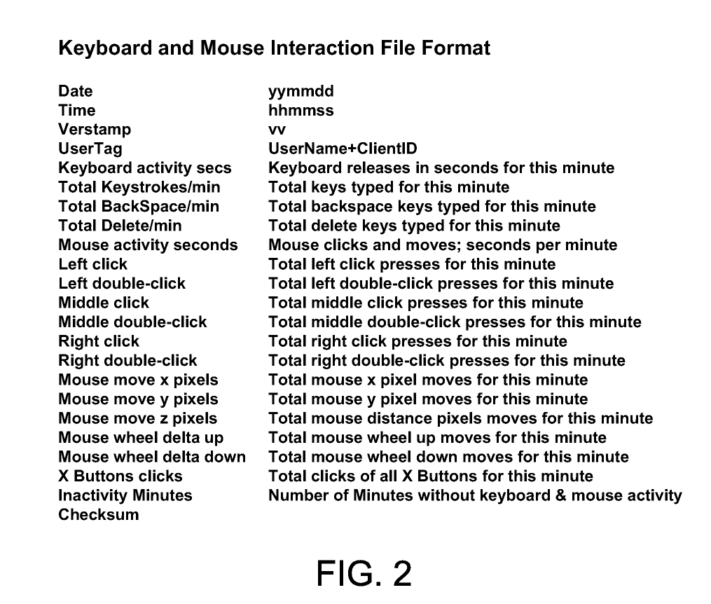

The first of the three workstream log files 115 is the keyboard and mouse workstream file. Each row in the file includes date and time stamps, a beacon version ID, a user tag (user name+client ID) and keyboard and mouse interaction data as detailed in FIG. 2.

Keystrokes are classified as one of three types: (1) correction (backspace and delete), (2) editing (arrow keys, page up, page down, home, end) and (3) standard (letters, numbers, punctuation, etc.). By default, keystroke data is accumulated in 60 second blocks, but the beacon can be configured for different intervals.

Mouse interactions are converted to an X,Y coordinate system and pixel distances (Z) are calculated and accumulated in 60 second blocks. Mouse button interactions (left, right, middle, scroll wheel, other) are also accumulated in 60 second blocks. Keyboard and mouse interaction blocks are closed when there is a change of focus event signifying a change in the active window or application.

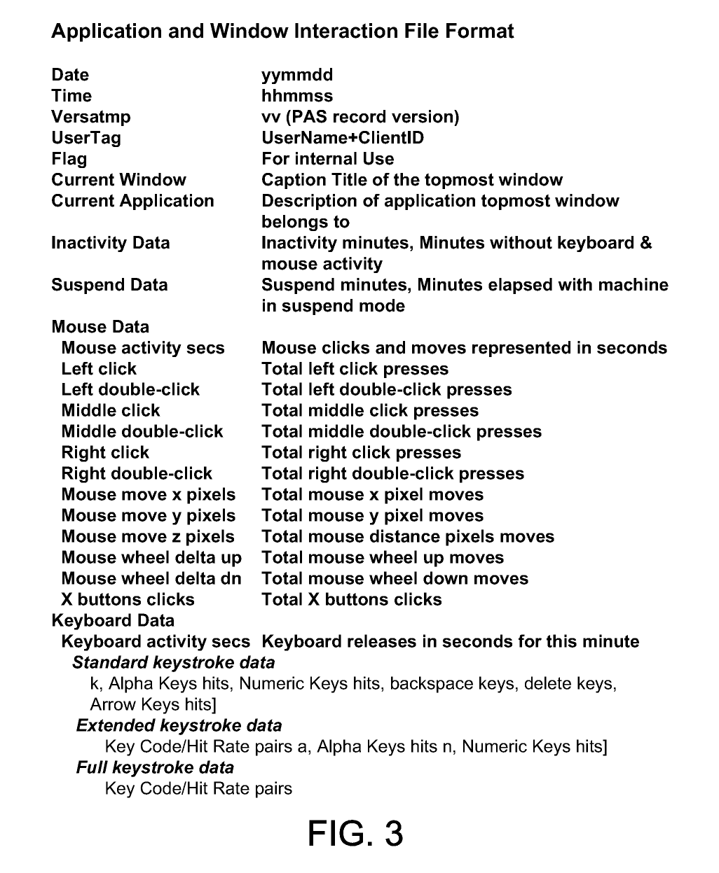

The second workstream log file 115 is the application and window workstream file. This file includes date and time stamps, a beacon version ID, a user tag (user name+client ID), current window title, current window application and additional interaction data as detailed in FIG. 3. Each row in the application and window workstream file represents a window or application interaction event. Depending upon the interaction type, additional fields may be included in each row. These fields may include dialog window titles, web URL addresses, HTTP snooping, file activity types, file names, media types and connection strings.

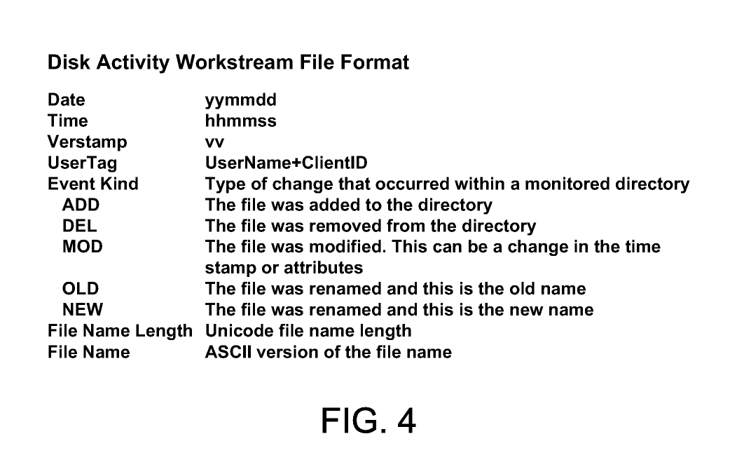

The third workstream log file 115 is the disk activity workstream file. This file includes date and time stamps, a beacon version ID, a user tag (user name+client ID), a file access type (add, delete, modify) and the other parameters shown in FIG. 4.

Workstream compression & SSL transmission module 120 is responsible for transferring the workstream log files 115 to archive server 135 which is a part of central data processing servers 130. Data transmission is accomplished over a secure VPN connection (125) that is encrypted and authenticated. Data is transferred using SOAP which allows data to be streamed over the HTTP port and use SSL for encryption. The preferred embodiment uses an open source program zlib for compression, but any standard compression protocol would be sufficient. Numbered packets and checksum calculation are used to verify the completeness and integrity of data transfers.

Central Data Processing Servers

Archive server 135 is a file server with a directory structure based on clientID and userID. Each userID subdirectory has three files: (1) a keyboard and mouse interaction file, (2) an application and window interaction file, and (3) file activity. Both files are of the same format as workstream log files 115. Data from the three log files transferred during each transmission (170) is appended to the end of a user's archive files. The preferred embodiment of the invention leaves transmitted data on the archive server in its encrypted and compressed state, but an alternative embodiment decompresses and decrypts the data for real time display and analysis.

Human-computer interaction workstreams appended to the files on the archive server 135 and scanned and reformatted (140) in real time. By scanning, the invention checks the workstream for field values which exceed a statistical measure or exception value previously defined by an administrator in the console 18. Workstreams from all users from a particular identified organization are parsed, reformatted and consolidated into a single CSV file.

Using standard database administrator tools, consolidated workstream CSV file 140 is loaded into relational database management system 145. The preferred embodiment of the invention specifies 6 tables in the RDBMS: key stream, mouse stream, application stream, internet stream, system/file stream and minute stream.

External data 155 from other business functions is uploaded through secure VPN 125 and loaded into the RDBMS 145. External data sources 155 include but are not limited to: Human Resource files, Geo-IP look-up tables, security access log files and environmental log files. External data 155 combined with workstream data 140 creates an integrated productivity database 145 that can be used to analyze data by user, department or job title, and calculate financial costs associated with productivity gaps.

External business data 155 from the client's Human Resources department is interfaced with workstream data 140 in master data management RDBMS 145. Interfaced data includes employee names, departments, job titles, performance ratings, pay rates, user IDs and other parameters that allow powerful analysis and reporting on workstream data 140.

External business data 155 also includes customized business rules that are loaded into the RDBMS 145 for analysis of workstream data. Business rules include, but are not limited to, work definitions, trade secret and intellectual property definitions and trigger tables.

Work definition rules identify applications, files, directories, domains, web URLs, key words and time/day parameters specifically related to a user's department and job function. By definition, human-computer interactions outside these parameters are deemed to be non-work related activities.

Trade secret and intellectual property rules 155 define what documents, file structures and other resources within the organization are deemed to be sensitive, confidential or trade secrets. By combining trade secret and intellectual property rules with user IDs, job functions and other HR parameters, and with workstream data, the invention identifies security risks and alerts security personnel to potential risks or actual breaches.

The invention optionally uses trigger rules. Trigger rules define applications, web sites and key words that are deemed to be restricted by the organization. Trigger rules can be focused by user IDs, departments, job functions and day/time rules. Combining trigger rules with HR data and workstream data provides an organization with the ability to identify inappropriate and/or inefficient activities.

Total quality management, best practices and Six Sigma analysis rules 155 identify user departments, job functions, elapsed time durations and defects (accuracy and fatigue keystrokes) specifically related to a software application work unit. By definition, human-computer interactions with fewer defects, shorter durations and fewer keystrokes and mouse inputs 9 are deemed to be superior work techniques.

Business structure rules 155 defined in a hierarchical view of the organization by business unit, geography and department provide a common measure for interdepartmental group comparisons of productivity reports, e.g. how do sales and finance compare when measured on average weekly work quantity and quality.

Business structure rules 155, defined in a functional view of the organization by business unit, geography, department and job class, provide a common measure for peer group comparisons of functional productivity. For example, how do numerous sales offices compare on average daily Microsoft PowerPoint Slideshows given.

Business structure rules 155, defined in a chronological hierarchy of the organization by business unit, geography, department and job class, provide a common measure for peer group comparisons of productivity by hour of day, day of week, week of year and month of year. For example, how does the first week of the month compare in efficiency across numerous sales offices. Outlier patterns can also identify potentially suspicious, unauthorized or even criminal activity.

Analysis, Alerts and Report Generation

Massive amounts of workstream data 140, combined with external business data 155, requires a powerful, multidimensional, analytical database capability (160). Any commercially available analytical database can be use with the invention. The preferred embodiment of the invention uses Query Object analytical software licensed from Internet Query Objects, Inc. This multidimensional analytical tool is capable of handling extremely large data sets and provides nearly instantaneous query results that can be easily filtered, sorted and cross tabulated.

Analytical database 160 is updated on an hourly basis from relational database 145. All possible fifteen at a time field combinations across workstream tables, business rules and external data are computed and then stored in an aggregate table array. A userID and timestamp comprise a key that is used to key back to relational database 145 for forensic examination.

Reports, triggered events, standard queries and ad hoc queries (165) are performed with Structured Query Language (SQL) which access multidimensional DB via Open Database Connectivity (ODBC). Therefore any ODBC compliant tool can be used to perform these analytical functions. Spreadsheet software (e.g. Microsoft Excel), Business Intelligence Tools (Business Objects) and statistical and data mining software (e.g. SAS) can all be used to create productivity reports, business intelligence dashboards and scorecards as well as predictive models. The preferred embodiment is a BI tool, such as Business Objects, which provides for standard reporting, triggered alerts delivered via email/instant messaging (IM), and easy to deploy scorecards and desktop dashboards.

Reports and triggers are processed at the end of the hourly update cycle. The reports are posted to a secure web portal 190 with email notification of their availability. Triggers are all detailed in an exception report. All or a subset of the triggers may initiate an email to notifying one or more recipients of an event which occurred.

A scripting language is used to control the initiation and processing of the updates and standard scorecard reports. The preferred language is PERL and PHP. An alternative is to use a batch file. Ad hoc activities are initiated by the user via their query, reporting and BI tools.

Key performance indicator Scorecards (KPI) with Baseline Productivity Metrics are posted to a secure web portal for client management review 175. For the productivity management application, the preferred embodiment is to generate baseline KPI scorecard reports, productivity outliers reports and diagnostic reports for non-reporting beacons.

These KPI scorecards contain the three hierarchical views of a business previously defined: (1) organizational, (2) functional and (3) chronological. Outlier productivity, defined as two standard deviations above or below the average, is identified for management review and action. If trade secret rules have been defined (155) then a listing of employees accessing trade secret documents outside authorized departments, time periods or individual personnel lists are identified.

Central Management Console

Each client has a web based console which provides real-time status of all beacons, active/inactive and daily productivity quantity in organizational hierarchical form, e.g. 1,400 Corp employees active out of 1,500 total employees, with breakdowns by dept and location. The client or administrator can also review individual employee beacons to see if a particular employee is active and how much work the particular employee has done a given day. A non-reporting beacon report provides a list of workstations that may need a reinstall of the beacon and new equipment that needs to have the beacon installed.

The Administrator Control Panel is a web based tool which provides beacon diagnostics, hierarchical enterprise customer displays, and on-demand initiation of any scripted database update or analytical process. The preferred control panel is written in html and php and is a collection of web pages and php scripts that control the entire function of the system.

The control panel can issue instructions to specific beacons, subsets of beacons or all beacons. Beacon management utilizes this feature to modify beacon activities, deploy newer versions of the beacon or deliver special one-time processing instructions.

Via the Administrator control panel, beacons can be instructed to stop transmission for a defined interval, stop logging and transmitting for a defined interval, update themselves with newer versions retrieved from the server or permanently uninstall themselves. The control panel can also be used to deliver specific instructions to an individual beacon, a subset of beacons, or all beacons. For example, the server could request a beacon to upload certain contact and calendar files from a workstation.

Special processing instructions are contained in an executable file, which the beacon downloads from the server. Instructions include, but are not limited to, file uploads/downloads and file deletion. This feature is useful in recovering data and disabling a stolen computer.

The above description is illustrative, and not restrictive. Many other embodiments will be apparent to those of skill in the art upon reviewing the above description. Determine the scope of the invention with reference to the appended claims, along with the full scope of equivalents to which such claims are entitled.

1. A computerized method for managing productivity in a human-computer environment, the method comprising:
monitoring human-computer interactions on a plurality of computing devices;
logging human-computer interactions on the plurality of computing devices;
transmitting logged data, from the plurality of computing devices, to a data management server;
indexing and archiving human-computer interaction data in a database; and
calculating and displaying statistical information from the archived data.

2. The method of claim 1, wherein human-computer interactions are logged without defining an event, keyword, or activity category to trigger logging.

3. The method of claim 1, wherein logged human-computer interactions include keystroke and mouse click statistics.

4. The method of claim 1, further comprising identifying changes in productivity and identifying a cost of the productivity change.

5. The method of claim 1, further comprising correlating archived data with data from external sources.

6. A computerized method for managing productivity in a human-computer environment, the method comprising:
monitoring human-computer interactions on a plurality of computing devices associated with an identified organization;
logging human-computer interactions on the plurality of computing devices, wherein keystroke sequences are not logged such that recreating human work content from logged keystrokes is not possible;
compressing logged data;
encrypting logged data;
transmitting logged data, from the plurality of computing devices, to a data management server;
indexing and archiving human-computer interaction data in a database;
correlating archived data with organizational structure data of the specified organization; and
calculating and displaying statistical information, from the archived data, about the identified organization.

7. The method of claim 6, wherein the organizational structure data includes data associated with organizational charts, job descriptions, human resources information, and location information.

8. The method of claim 6, further comprising quantifying costs over time associated with organizational structure changes.

9. A computerized method for managing productivity in a human-computer environment, the method comprising:
monitoring human-computer interactions on a plurality of computing devices associated with an identified organization;
logging human-computer interactions on the plurality of computing devices, wherein keystroke sequences, passwords, and account numbers are not logged such that recreating human work content from logged keystrokes is not possible, and wherein human-computer interactions are logged without defining an event, keyword, or category or interaction to trigger monitoring and logging;
compressing logged data;
encrypting logged data;
transmitting logged data, from the plurality of computing devices, to a data management server;
indexing and archiving human-computer interaction data in a relational database, wherein the relational database aggregates interaction data from the plurality of computing devices;
correlating archived data with organizational structure data of the specified organization;
analyzing logged data to derive quantitative measurements of productivity; and
displaying productivity measurements.

10. The method of claim 9, further comprising correlating archived data with external data sources.

11. The method of claim 9, further comprising identifying computing devices that have ceased to transmit data to the data management server.

12. The method of claim 9, further comprising automatically generating productivity measurements from the archived data.

13. The method of claim 9, further comprising disabling a computing device in response to user instructions.

14. A computerized method for managing productivity in a human-computer environment, the method comprising:
monitoring human-computer interactions on a plurality of computing devices associated with an identified organization;
logging human-computer interactions on the plurality of computing devices, wherein keystroke sequences, passwords, and account numbers are not logged such that recreating human work content from logged keystrokes is not possible, and wherein human-computer interactions are logged without defining an event, keyword, or category or interaction to trigger monitoring and logging;
compressing logged data;
encrypting logged data;
transmitting logged data, from the plurality of computing devices, to a data management server;
indexing and archiving human-computer interaction data in a relational database, wherein the relational database aggregates interaction data from the plurality of computing devices;
correlating archived data with organizational structure data of the specified organization;
comparing computer device usage statistics to a baseline set of metrics to identify changes in productivity; and
calculating and displaying productivity measurements.

15. The method of claim 14, further comprising correlating archived data with environmental data.

16. The method of claim 14, wherein productivity measurements include measuring user fatigue.

17. The method of claim 14, further comprising measuring an amount of paid internet advertising accessed by users of client computing devices.

18. The method of claim 14, further comprising automatically categorizing work and non-work workstream log entries.

19. The method of claim 14, automatically identifying and tracking locations from where workstream logs are transmitted;

20. A computerized method for managing productivity in a human-computer environment, the method comprising:
monitoring all human-computer interactions on a plurality of computing devices associated with an identified organization using a client software application;
wherein human-computer interactions include keyboard activity, mouse activity, computer application activity, internet and web activity, electronic mail, communication activities, file access, and hardware level disk operations;
logging human-computer interactions on the plurality of computing devices, wherein keystroke sequences, passwords, and account numbers are not logged such that recreating human work content from logged keystrokes is not possible, and wherein human-computer interactions are logged without defining an event, keyword, or category or interaction to trigger monitoring and logging;
compressing logged data;
encrypting logged data;
transmitting logged data, from the plurality of computing devices, to a data management server;
indexing and archiving human-computer interaction data in a relational database, wherein the relational database aggregates interaction data from the plurality of computing devices;
correlating archived data with organizational structure data of the specified organization using an analytical database;
analyzing logged data to derive quantitative measurements of productivity; and
displaying productivity measurements.

21. The method of claim 20, wherein the client software application runs on at least WINDOWS, LINUX, and APPLE computer operating systems.

22. The method of claim 20, wherein the client software application is automatically updated.

23. The method of claim 20, wherein a SOAP-based communication client is used for compressing, encrypting and transmitting human-computer interaction data.
